(19) United States
(12) Patent Application Publication
(10) Pub. No.: US 2025/0157272 A1
(43) Pub. Date: May 15, 2025

(54) METHOD FOR REDUCING HYDROGEN EVAPORATION LOSSES

(71) Applicant: L'Air Liquide, Societe Anonyme pour l'Etude et l’Exploitation des Procedes Georges Claude, Paris (FR)

(72) Inventors: Kai Jun KOH, Paris (FR); Guillaume PETITPAS, Les Loges en Josas (FR); Claire GIRARD, Les Loges en Josas (FR)

(21) Appl. No.: 18/940,182

(22) Filed: Nov. 7, 2024

(30) Foreign Application Priority Data
Nov. 9, 2023 (FR) FR 2312196

(51) Int. Cl. G07C 5/08

(52) U.S. Cl. CPC G07C 5/0816; G07C 5/0808

(57) ABSTRACT

The invention relates to a method for reducing hydrogen losses in a liquid hydrogen tank, this tank being refillable and installed on board a vehicle, being provided with a vent for discharging gaseous dihydrogen out of the tank in the event of overpressure, the method comprising the following steps:
providing data on the next refill of the tank as a function of a next parking operation of the vehicle planned after the next refill, this data providing at least a target fill level to be reached for the next refill, this target fill level being determined in such a way that, at the start of the parking operation of the vehicle after a possible journey of the vehicle between the refill to the target fill level and the start of the parking operation, the tank has a start-of-parking fill level designed such that, for the duration of this parking operation, the loss of dihydrogen through the vent is minimized.

### CROSS-REFERENCE TO RELATED APPLICATIONS

This application claims the benefit of priority under 35 U.S.C. § 119 (a) and (b) to French patent application No. FR 2312196, filed Nov. 9, 2023, the entire contents of which are incorporated herein by reference.

### BACKGROUND

The present invention relates to a method for reducing hydrogen evaporation losses in a liquid hydrogen tank, this tank being refillable and installed on board a vehicle.

### FIELD OF THE INVENTION

Cryogenically storing hydrogen in a vehicle (car, truck, ship, train, aeroplane, etc.) offers increased range for journeys made by the vehicle. One major disadvantage linked to this storage method is evaporation of the hydrogen (a phenomenon referred to as “boil-off”), which is caused by heat being transferred between the outside and the hydrogen that is stored at temperatures of between 20 and 150 kelvins. Evaporation leads to losses through the vent, which increases the carbon footprint and the operating costs. There is a crucial need to reduce these losses.

The present invention aims in particular to overcome this problem.

### RELATED ART

The invention therefore relates to a method for reducing hydrogen evaporation losses in a liquid hydrogen tank, this tank being refillable and installed on board a (land, sea, air or space) vehicle in order to supply, for example, a fuel cell of the vehicle, the tank being provided with a vent for discharging gaseous dihydrogen out of the tank in the event of overpressure, the method comprising the following steps:
providing data on the next refill of the liquid hydrogen tank as a function of a next parking operation of the vehicle planned after the next refill, this next refill data providing at least a target fill level (L-targ) to be reached for the next refill of the tank, this target fill level (L-targ) being determined in such a way that, at the start of the parking operation of the vehicle after a possible journey of the vehicle between the refill to the target fill level (L-targ) and the start of the parking operation, the tank has a start-of-parking fill level (L-park) designed such that, for the duration of this next parking operation of the vehicle, the loss of dihydrogen through the tank vent is minimized.

The invention advantageously makes it possible, using the data on the next refill of the tank, to guide the driver/pilot of the vehicle equipped with the cryogenic liquid hydrogen tank in order to optimize the refuelling strategy and minimize evaporation losses. The invention is particularly advantageous for intensive use applications, for example for a truck used all day, alternating between driving and parking phases.

During parking phases of the vehicle, when hydrogen evaporation can occur, it is important to place the tank in conditions that minimize losses through the vent. This is made possible by the present invention.

### SUMMARY OF THE INVENTION

In the present invention, during the parking phase (i.e., the vehicle is stopped with the engine switched off), the liquid hydrogen tank stops supplying the fuel cell. A parking phase is different, in particular, from a simple stop at a red light or a brief stop to refill the tank with hydrogen at the service station. When parked within the meaning of the invention, the fuel cell is at rest.

According to one of the aspects of the invention, the duration of parking is at least one hour or two hours, or indeed longer, for example at least five hours or eight hours.

It should be noted that, when the vehicle is being driven, the withdrawal of hydrogen by the cell reduces the pressure in the tank. Moreover, thermodynamic stratification (the development of a thermal gradient across the height of the tank) increases the pressure in a static tank more than in a moving tank. Therefore, when driving, the “boil-off” phenomenon is less critical.

The aim of the invention is to determine the target fill level (L-targ) to be reached for the next refill of the tank so that, at the start of the parking operation, the tank is filled to the start-of-parking fill level (L-park). In practice, the user/driver does not necessarily need to know the value of the start-of-parking fill level (L-park). The user/driver needs to know the target fill level (L-targ) to be reached for the next refill of the tank, because he or she will refill the tank knowing this target level. The user/driver may, for example, input the level value (L-targ) at the filling station, and this station automatically refills the tank to the level (L-targ). This level (L-targ) may also be reached manually by the user. As a variant, in the event that refilling takes place entirely automatically, the user/driver does not need to know the target fill level (L-targ) to be reached, and the filling station receives this data in order to perform the refilling operation automatically.

According to one of the aspects of the invention, the vehicle equipped with the liquid hydrogen tank is a road motor vehicle such as a truck, in particular weighing at least 3.5 tonnes, or a bus, in particular having at least 8 seats.

According to one of the aspects of the invention, the vehicle equipped with the liquid hydrogen tank is a train or a ship or an aeroplane.

According to one of the aspects of the invention, the target fill level (L-targ) provided by the next refill data is correlated to an instant (date/time) planned for the next refill.

According to one of the aspects of the invention, the next refill data is determined at least as a function of the duration of the next parking operation of the vehicle.

According to one of the aspects of the invention, the duration of parking is at least one hour or two hours, or indeed longer, for example at least five hours or eight hours.

According to one of the aspects of the invention, the next refill data is determined at least as a function of a dormancy parameter which represents the latency before the tank is vented (through the vent) due to the pressure in the tank increasing as the hydrogen evaporates.

The higher the value of this dormancy parameter, for a given situation, the longer the release of evaporated hydrogen out of the tank is delayed. This is advantageous because it helps reduce evaporation losses.

According to one of the aspects of the invention, the determination of the next refill data uses a thermodynamic model providing a relationship between the dormancy parameter and the start-of-parking fill level (L-park), and possibly also linked to the pressure inside the tank.

According to one of the aspects of the invention, the thermodynamic model is in the form of a correspondence table associating the tank fill percentage (or start-of-parking fill level (L-park)) with values of the dormancy parameter, and possibly also the pressure inside the tank.

By providing next refill data for refilling the tank at the refuelling station, the method according to the invention makes it possible to ensure that, during the next parking operation of the vehicle, the target fill level (L-targ) of the tank is adapted to the duration of parking. The evaporation of hydrogen that occurs during this parking phase is minimized by using the thermodynamic model and by anticipating the vehicle's journey, and more generally the vehicle's route plan.

According to one of the aspects of the invention, the next refill data is determined as a function of two different thermodynamic models, using one of the models, for example, if the duration of the next parking operation is less than a predetermined threshold, and using the other model if the duration of the next parking operation of the vehicle is greater than this predetermined threshold.

As described above, one of the models may use the dormancy parameter and the other thermodynamic model may, for example, use a parameter reflecting the accumulation of evaporated hydrogen which is vented out of the tank.

Therefore, depending in particular on the duration of the next parking operation of the vehicle, the next refill data may be determined based on one or the other of the models, depending on the duration of the next parking operation.

For example, the dormancy parameter is maximized to a value of 50% if the liquid hydrogen is stored in the tank at a pressure of 10 bar.

For example, the thermodynamic model uses a parameter reflecting the accumulation of evaporated hydrogen which is vented out of the tank.

According to one of the aspects of the invention, in the event that the next parking operation of the vehicle is to last N hours, the next refill data is determined by taking into account this duration of parking of the vehicle.

According to one of the aspects of the invention, the next refill data also takes into account the consumption of liquid hydrogen during a journey of the vehicle between the instant the next refill data is provided and the instant the vehicle reaches a liquid hydrogen refuelling station.

According to one of the aspects of the invention, the next refill data also takes into account a possible journey that the vehicle needs to make between the refuelling station and the place where the vehicle will park, for example a car park or a garage.

According to one of the aspects of the invention, the next refill data is also determined as a function of vehicle journey data and/or data relating to the vehicle's surroundings, for example the outside temperature.

According to one of the aspects of the invention, the next refill data is also determined as a function of data relating to the vehicle's journey history.

According to one of the aspects of the invention, the vehicle journey data is, for example, the average mileage covered by the vehicle during a normal journey day.

According to one of the aspects of the invention, the journey data also comprises, for example, the usual time at which the vehicle is parked, for example at 7:00 p.m., when the working day has finished.

The duration of parking may be set at 8 or 12 hours, for example, when the vehicle is parked overnight.

According to one of the aspects of the invention, the next refill data is determined as a function of data input by the user via a human-machine interface. This input data relates, for example, to the journey that the user plans to make, in particular the journeys just before and just after the next refill.

The invention also relates to a system for reducing hydrogen evaporation losses (boil-off) in a liquid hydrogen tank, this tank being refillable and installed on board a (land, sea, air or space) vehicle in order to supply, for example, a fuel cell of the vehicle, the tank being provided with a vent for discharging gaseous dihydrogen out of the tank in the event of overpressure, the system being configured to:
provide data on the next refill of the liquid hydrogen tank as a function of a next parking operation of the vehicle planned after the next refill, this next refill data providing at least a target fill level (L-targ) to be reached for the next refill of the tank, this target fill level (L-targ) being determined in such a way that, at the start of the parking operation of the vehicle after a possible journey of the vehicle between the refill to the target fill level (L-targ) and the start of the parking operation, the tank has a start-of-parking fill level (L-park) designed such that, for the duration of this next parking operation of the vehicle, the loss of dihydrogen through the tank vent is minimized.

According to one of the aspects of the invention, the system comprises a data processing unit, in particular a computer, configured to receive data on the duration of the next parking operation of the vehicle, and determine data relating to the target fill level (L-targ) of the tank for the next refill at least depending on the duration of the next parking operation of the vehicle.

According to one of the aspects of the invention, the data processing unit is configured to receive vehicle journey data and/or data relating to the vehicle's surroundings, for example the outside temperature, and use this data when determining the data relating to the target fill level (L-targ) of the tank for the next refill.

According to one of the aspects of the invention, the data processing unit is installed on board the vehicle (being an on-board computer of the vehicle), and may possibly communicate with a remote server.

The data processing unit installed on board the vehicle is linked to software based on a remote server for more complex calculation operations.

According to one of the aspects of the invention, the data processing unit is remote (connected to the vehicle remotely).

In particular, the data processing unit is a remote computing unit whose memory contains the typical driving cycles.

According to one of the aspects of the invention, the system comprises a human-machine interface for providing the driver with information on the target fill level (L-targ) of the tank for the next refill.

According to one of the aspects of the invention, the system is configured to complete at least some of the following steps:
processing data from sensors such as gauges measuring the level of liquid hydrogen in the tank;
processing data relating to a driving cycle;
retrieving a journey history of the vehicle;
communicating with a liquid hydrogen refuelling network database and GPS;
calculating next refill data including, in particular, a next refuelling location, a timetable and information on the target fill level (L-targ) of the tank;
displaying this next refill data to the user via a human-machine interface.

According to one of the aspects of the invention, at least one pressure sensor and/or one level sensor is placed in the liquid hydrogen tank.

### BRIEF DESCRIPTION OF THE FIGURES

Further features, details and advantages of the invention will become more clearly apparent from reading the following description, and from a number of exemplary embodiments given by way of non-limiting indication, with reference to the appended schematic drawings, in which:

FIG. 1 is a schematic representation of a system for reducing hydrogen losses according to the invention;

FIG. 2 shows dormancy curves used by the system of FIG. 1;

FIG. 3 shows curves of the quantity of vented hydrogen;

FIG. 4 is a block diagram showing a method according to one embodiment of the invention.

### DETAILED DESCRIPTION OF THE INVENTION

The features, variants and different embodiments of the invention can be associated with each other in various combinations, provided they are not incompatible with or exclusive of each other. In particular, it is possible to envisage variants of the invention that only comprise a selection of the features described below in isolation from the other described features, if said selection of features is sufficient to give the invention a technical advantage over and/or distinguish it from the prior art.

FIG. 1 shows a system 100 for reducing hydrogen evaporation losses (or “boil-off”) in a liquid hydrogen tank 10, this tank 10 being refillable and installed on board a road vehicle V, in this instance a truck, in order to supply a fuel cell (not shown here) of the vehicle V.

The tank 10 is provided with a vent 11 for discharging gaseous dihydrogen out of the tank 10 in the event of overpressure.

The system 100 is configured to provide data on the next refill of the liquid hydrogen tank 10 as a function of a next parking operation of the vehicle planned after the next refill, this next refill data providing at least a target fill level (L-targ) to be reached for the next refill of the tank 10, this target fill level (L-targ) being determined in such a way that, at the start of the parking operation of the vehicle V after a possible journey of the vehicle between the refill to the target fill level (L-targ) and the start of the parking operation, the tank 10 has a start-of-parking fill level (L-park) designed such that, for the duration D of this next parking operation of the vehicle, the loss of dihydrogen through the tank vent 10 is minimized. These aspects are described in greater detail below.

The system 100 comprises a data processing unit 101, such as a computer, configured to:
receive data on the duration of the next parking operation of the vehicle, and determine data relating to the target fill level (L-targ) of the tank 10 for the next refill at least depending on the duration of the next parking operation of the vehicle, and/or
receive vehicle journey data and/or data relating to the vehicle's surroundings, for example the outside temperature, and use this data when determining the data relating to the target fill level (L-targ) of the tank for the next refill.

The data processing unit 101 is installed on board the vehicle V and can communicate with a remote server 120, also referred to as the cloud.

The data processing unit 101 installed on board the vehicle V is linked to a computer 130 on the remote server 120 for more complex calculation operations.

The remote server 120 contains, in a memory 135, data relating to the history of driving and/or refill cycles.

Therefore, the next refill data is determined, if applicable, by taking into account data relating to a journey history of the vehicle V.

The journey data of the vehicle V is, for example, the average mileage covered by the vehicle during a normal journey day.

The journey data also comprises, for example, the usual time at which the vehicle is parked, for example at 6:00 p.m. or 7:00 p.m., when the working day has finished.

The duration of parking may be set at 8, 10 or 12 hours, for example, when the vehicle is parked overnight.

The next refill data may also be determined as a function of data input by the user via a human-machine interface 105. This input data relates, for example, to the journey that the user plans to make, in particular the journeys just before and just after the next refill.

The human-machine interface 105, for example a touch screen permanently installed in the vehicle V or a smartphone in the hands of the driver C, is used to provide the driver with information on the target fill level (L-targ) of the tank for the next refill.

The remote server 120 contains a database 137 of the location of liquid hydrogen refuelling stations, for example in the form of a map of the network of liquid hydrogen refuelling stations. This database 137 may be updated regularly.

The system 100 is configured to perform the following steps:
processing data from sensors 111 such as gauges measuring the level of liquid hydrogen in the tank 10;
processing data relating to a driving cycle;
retrieving a journey history of the vehicle from the memory 135;
communicating with the liquid hydrogen refuelling network database 137 and GPS;
calculating next refill data including, in particular, a next refuelling location, a timetable and information on the target fill level (L-targ) of the tank;
displaying this next refill data to the user via the human-machine interface 105.

At least one pressure sensor 111 and/or one liquid hydrogen level sensor 111 is placed in the liquid hydrogen tank 10.

The system 100 can be used to implement a method for reducing hydrogen evaporation losses through the vent 11 of the tank 10, the method comprising the following steps:
providing data on the next refill of the liquid hydrogen tank 10 as a function of a next parking operation of the vehicle V planned after the next refill, this next refill data providing at least a target fill level (L-targ) to be reached for the next refill of the tank, this target fill level (L-targ) being determined in such a way that, at the start of the parking operation of the vehicle after a possible journey of the vehicle between the refill to the target fill level (L-targ) and the start of the parking operation, the tank has a start-of-parking fill level (L-park) designed such that, for the duration of this next parking operation of the vehicle V, the loss of dihydrogen through the tank vent is minimized.

The invention advantageously makes it possible, using the data on the next refill of the tank 10, to guide the driver/pilot of the vehicle equipped with the cryogenic liquid hydrogen tank in order to optimize the refuelling strategy and minimize losses through the vent 11. The invention is particularly advantageous for intensive use applications, for example for a truck used all day, alternating between driving and parking phases.

During parking phases of the vehicle, when hydrogen evaporation can occur, it is important to place the tank in conditions that minimize losses through the vent. This is made possible by the present invention.

In the present invention, during the parking phase (i.e., the vehicle is stopped with the engine switched off), the liquid hydrogen tank stops supplying the fuel cell. A parking phase is different, in particular, from a simple stop at a red light or a brief stop to refill the tank with hydrogen at the service station. When parked within the meaning of the invention, the fuel cell is at rest.

According to one of the aspects of the invention, the duration of parking is at least one hour or two hours, or indeed longer, for example at least five hours or eight hours.

The aim of the invention is to determine the target fill level (L-targ) to be reached for the next refill of the tank so that, at the start of the parking operation, the tank is filled to the start-of-parking fill level (L-park). In practice, the user/driver does not necessarily need to know the value of the start-of-parking fill level (L-park). The user/driver needs to know the target fill level (L-targ) to be reached for the next refill of the tank, because he or she will refill the tank knowing this target level. The user/driver may, for example, input the level value (L-targ) at the filling station, and this station automatically refills the tank to the level (L-targ). This level (L-targ) may also be reached manually by the user. As a variant, in the event that refilling takes place entirely automatically, the user/driver does not need to know the target fill level (L-targ) to be reached, and the filling station receives this data in order to perform the refilling operation automatically.

Preferably, the target fill level (L-targ) provided by the next refill data is correlated to an instant (date/time) planned for the next refill.

Preferably, the next refill data is determined at least depending on the duration of the next parking operation of the vehicle.

Preferably, the duration of parking is at least one hour or two hours, or indeed longer, for example at least five hours or eight hours.

In the described example, the next refill data is determined at least as a function of a dormancy parameter DORM which represents the latency before the tank is vented (through the vent 11) due to the pressure in the tank increasing as the hydrogen evaporates.

The dormancy parameter DORM in this case uses the number of days as the unit and the assumption that the thermal input to the tank is 5 Watts.

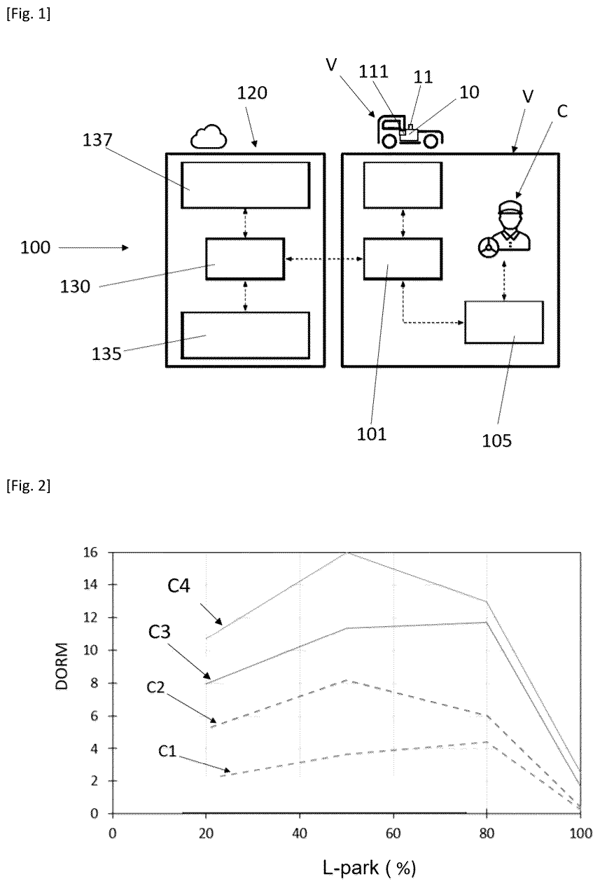

FIG. 2 shows curves C1 to C4 with the fill level of the tank L-park (expressed as the tank 10 fill percentage) on the X-axis, and the dormancy parameter DORM (expressed as the number of days) on the Y-axis.

The higher the value of this dormancy parameter DORM, for a given situation, the longer the release of evaporated hydrogen out of the tank is delayed. This is advantageous because it helps reduce losses through the vent 11.

Curve C1 corresponds to a model of the variation of the dormancy parameter DORM for liquid hydrogen LH2 at a pressure of between 6 and 10 bar, except at the 100% fill value for which the pressure is between 8 and 10 bar.

Curve C2 corresponds to a model of the variation of the dormancy parameter DORM for sub-cooled liquid hydrogen sLH2 at a pressure of between 6 and 20 bar, except at the 100% fill value for which the pressure is between 16 and 20 bar.

Curve C3 corresponds to a model of a case involving liquid hydrogen LH2 for a pressure varying from 1 to 10 bar.

Curve C4 corresponds to a model of a case involving hydrogen sLH2 for a pressure varying from 1 to 20 bar.

For example, curve C1 shows that the dormancy parameter DORM is at a maximum when the fill level is 80%.

Curve C2 shows that the dormancy parameter DORM is at a maximum when the fill level is 50%.

It can be seen that, unexpectedly, it is not always desirable to fill the tank to 100% if the aim is to reduce the risk of hydrogen losses through the vent.

The determination of the next refill data uses a thermodynamic model providing a relationship between the dormancy parameter and the start-of-parking fill level (L-park), and possibly also linked to the pressure inside the tank.

In the described example, the thermodynamic model is in the form of a correspondence table associating the tank fill percentage (or start-of-parking fill level (L-park)) with values of the dormancy parameter, and possibly also the pressure inside the tank.

By providing next refill data for refilling the tank at the refuelling station, the method according to the invention makes it possible to ensure that, during the next parking operation of the vehicle, the target refill level (L-targ) of the tank is adapted to the duration of parking. The evaporation of hydrogen that occurs during this parking phase is minimized by using the thermodynamic model and by anticipating the vehicle's journey, and more generally the route plan of the vehicle V.

In one embodiment of the invention, the next refill data is determined as a function of two different thermodynamic models, using one of the models, for example, if the duration of the next parking operation is less than a predetermined threshold, and using the other model if the duration of the next parking operation of the vehicle is greater than this predetermined threshold.

As described above, one of the models may use the dormancy parameter and the other thermodynamic model may, for example, use a parameter reflecting the accumulation of evaporated hydrogen which is vented out of the tank 10.

Therefore, depending in particular on the duration of the next parking operation of the vehicle, the next refill data may be determined based on one or the other of the models, depending on the duration of the next parking operation.

Another thermodynamic model will now be described.

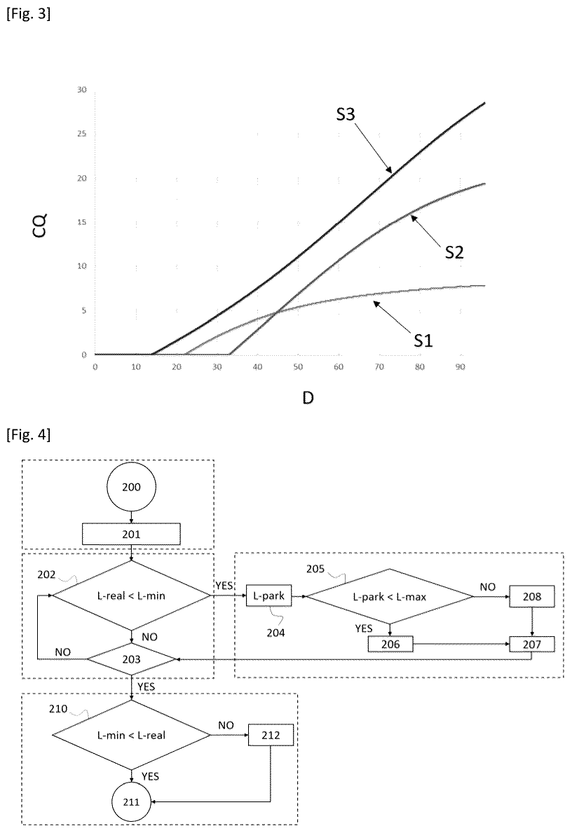

FIG. 3 shows curves S1 to S3 with the duration D in hours since the start of the parking operation on the X-axis, and with the accumulated quantity CQ of hydrogen vented through the vent 11, expressed in kg, on the Y-axis.

Curves S1 to S3 model the behaviour of sub-cooled liquid hydrogen (sLH2) with a maximum allowable working pressure (also referred to as MAWP) of 20 bar, assuming that the pressure at the start of the parking operation at D=0 is 6 bar.

These curves were obtained for a thermal input of 30 Watts.

Curve S1 corresponds to a fill level of the tank L-park of 20% at the start of the parking operation (D=0).

Curve S2 corresponds to a fill level of the tank L-park of 50% at the start of the parking operation (D=0).

Curve S3 corresponds to a fill level of the tank L-park of 80% at the start of the parking operation (D=0).

It can be seen that, for example, after a parking period of 45 hours, a tank that was initially 20% full (curve S1) has less accumulated vented hydrogen losses than if the tank had been 50% full at the start of the parking operation (curve S2).

Therefore, depending on the duration of parking, it may be more advisable to fill the tank to a lower level in order to reduce losses through the vent.

Other parameters can be taken into account.

For example, in the event that the next parking operation of the vehicle is to last N hours, the next refill data is determined by taking into account this duration of parking of the vehicle.

The next refill data also takes into account the consumption of liquid hydrogen during a journey of the vehicle between the instant the next refill data is provided and the instant the vehicle reaches a liquid hydrogen refuelling station.

The next refill data also takes into account a possible journey that the vehicle needs to make between the refuelling station and the place where the vehicle will park, for example a car park or a garage.

The next refill data is also determined as a function of vehicle journey data and/or data relating to the vehicle's surroundings, for example the outside temperature.

Different steps of a method according to one embodiment of the invention are now described in reference to FIG. 4.

This method begins at the start (step 200) of a daily use cycle of the vehicle V.

At this start of the daily cycle, a lower limit (L-min) and an upper limit (L-max) of the fill level of the tank 10 are calculated (step 201); these limits are recommended for the end of the day, just before the start of the parking operation. This is an initialization.

While the vehicle V is driving during the day, the system 100 checks, in real time or at regular time intervals, whether the current fill level (L-real) of the tank 10 is less than the lower limit (L-min), i.e., whether L-real<L-min (step 202).

As long as the current fill level L-real does not drop below the lower limit L-min, monitoring is carried out (step 203) to determine whether a next parking operation begins.

Step 202 is repeated for as long as the parking operation has not begun.

If the current fill level L-real drops below the lower limit L-min, it is deduced that a next refill of the tank 10 is necessary.

At this instant, in step 204, the start-of-parking fill level L-park is calculated.

Next, in step 205, it is determined whether the start-of-parking fill level L-park is less than the upper limit L-max.

If L-park is less than L-max, L-targ is given a value of 100% (step 206).

The next step is a step 206 of filling the tank, which is filled to a level of 100%. In other words, the level L-targ is set to 100%.

If it is determined in step 205 that L-park is greater than L-max, step 208 is carried out, which involves calculating a target fill level L-targ to be reached for the next refill. Once this step 208 has been carried out, the tank is refilled in step 207.

In step 203, if the instant when the parking operation begins arrives, step 210 is carried out, in which a comparison is made between the current fill level L-real and the lower limit L-min.

If the current fill level L-real (which then substantially corresponds to L-park) is greater than the lower limit L-min, the parking operation can effectively begin in step 211.

However, if the current fill level L-real is less than the lower fill limit L-min, the recommendation to refill the tank 10 to the target fill level L-targ is issued (step 212).

It may be possible to park with a tank filled to a value different from L-targ, for example in order to avoid a refill operation before the parking phase, if it is not necessary.

The aim of the described steps is to maximize the dormancy parameter.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for reducing hydrogen evaporation losses in a liquid hydrogen tank, the tank being refillable and installed on board a vehicle in order to supply the vehicle, the tank being provided with a vent for discharging gaseous hydrogen out of the tank in the event of overpressure, the method comprising the following steps:
providing data on the next refill of the liquid hydrogen tank as a function of a next parking operation of the vehicle planned after the next refill, the next refill data providing at least a target fill level to be reached for the next refill of the liquid hydrogen tank, the target fill level being determined in such a way that, at the start of the parking operation of the vehicle after a possible journey of the vehicle between the refill to the target fill level and the start of the parking operation, the liquid hydrogen tank has a start-of-parking fill level designed such that, for the duration of this next parking operation of the vehicle, the loss of hydrogen through the liquid hydrogen tank vent is minimized.

2. The method according to claim 1, in which the next refill data is determined at least as a function of a dormancy parameter which represents a latency before the liquid hydrogen tank is vented due to a pressure inside the liquid hydrogen tank increasing as the hydrogen evaporates.

3. The method according to claim 2, in which the determination of the next refill data uses a thermodynamic model providing a relationship between the dormancy parameter and the start-of-parking fill level.

4. The method according to claim 3, in which the thermodynamic model is in the form of a correspondence table associating a liquid hydrogen tank fill percentage, or the start-of-parking fill level, with values of the dormancy parameter.

5. The method according to claim 1, in which the next refill data is determined as a function of two different thermodynamic models, using one of the models if the duration of the next parking operation is less than a predetermined threshold, and using the other model if the duration of the next parking operation of the vehicle is greater than the predetermined threshold.

6. The method according to claim 1, in which the next refill data also takes into account a consumption of liquid hydrogen during a journey of the vehicle between the instant the next refill data is provided and the instant the vehicle reaches a liquid hydrogen refuelling station.

7. The method according to claim 1, in which the next refill data is also determined as a function of data relating to a vehicle's journey history.

8. The method according to claim 1, in which the next refill data is determined as a function of data input by a user via a human-machine interface.

9. A system for reducing hydrogen evaporation losses in a liquid hydrogen tank, the liquid hydrogen tank being refillable and installed on board a vehicle in order to supply the vehicle, the liquid hydrogen tank being provided with a vent for discharging gaseous hydrogen out of the liquid hydrogen tank in the event of overpressure, the system being configured to:
provide data on a next refill of the liquid hydrogen tank as a function of a next parking operation of the vehicle planned after the next refill, the next refill data providing at least a target fill level to be reached for the next refill of the liquid hydrogen tank, this target fill level being determined in such a way that, at the start of the parking operation of the vehicle after a possible journey of the vehicle between the refill to the target fill level and the start of the parking operation, the liquid hydrogen tank has a start-of-parking fill level designed such that, for the duration of this next parking operation of the vehicle, the loss of hydrogen through the liquid hydrogen tank vent is minimized.

10. The system according to claim 9, in which the system comprises a data processing unit configured to receive data on a duration of the next parking operation of the vehicle, and determine data relating to the target fill level of the liquid hydrogen tank for the next refill at least depending on the duration of the next parking operation of the vehicle.

11. The system according to claim 10, in which the data processing unit is configured to receive vehicle journey data and/or data relating to the vehicle's surroundings and use this data when determining the data relating to the target fill level of the liquid hydrogen tank for the next refill.

12. The system according to claim 9, in which the system is configured to perform at least one of the following steps:
processing data from sensors measuring a level of liquid hydrogen in the liquid hydrogen tank;
processing data relating to a driving cycle;
retrieving a journey history of the vehicle;
communicating with a liquid hydrogen refuelling network database and GPS;
calculating next refill data comprising a next refuelling location, a timetable and information on the target fill level of the liquid hydrogen tank;
displaying the next refill data to a user via a human-machine interface.
